(19) United States
(12) Patent Application Publication
(10) Pub. No.: US 2013/0331501 A1
(43) Pub. Date: Dec. 12, 2013

(54) ISOLATION OF CARBON NANOTUBES BY CHEMICAL FUNCTIONALIZATION

(71) Applicant: Cal Poly Corporation, San Luis Obispo, CA (US)

(72) Inventors: Phillip J. Costanzo, San Luis Obispo, CA (US); Keith Vorst, Arroyo Grande, CA (US); Greg William Curtzwiler, San Luis Obispo, CA (US)

(73) Assignee: Cal Poly Corporation, San Luis Obispo, CA (US)

(21) Appl. No.: 13/967,277

(22) Filed: Aug. 14, 2013

Related U.S. Application Data
(63) Continuation-in-part of application No. 12/750,535, filed on Mar. 30, 2010, now abandoned.
(60) Provisional application No. 61/165,833, filed on Apr. 1, 2009.

(51) Int. Cl. C01B 31/02; C09D 175/04

(52) U.S. Cl. CPC C01B 31/0273; C09D 175/04
USPC 524/507; 526/280; 526/232.1; 526/172

(57) ABSTRACT

Embodiments of the present disclosure illustrate systems and methods for the separation of carbon nanotubes (CNTs) in solution and continuously fabrication of functionalized carbon nanotubes (CNTs). In certain embodiments, the CNTs are isolated by sonication and chemical modification of the CNTs using functionalization reactions, including thermo-initiated or sono-initiated free radical polymerization and esterification. Beneficially, sonication facilitates mechanical separation of the CNTs, while the chemical modification of the CNTs results in more favorable interactions between the CNTs and their surrounding media which enables the separated CNTs to remain isolated. Embodiments of the isolated CNTs may also be employed into coating systems.

### RELATED APPLICATIONS

This application is a continuation in part application of U.S. patent application Ser. No. 12/750,535, filed on Mar. 30, 2010, which claims the benefit of priority under 35 U.S.C. §119(e) of U.S. Provisional Application No. 61/165,833, filed Apr. 1, 2009 and entitled “ISOLATION OF CARBON NANOTUBES BY CHEMICAL FUNCTIONALIZATION.” All of the above-described applications are hereby incorporated by reference in their entireties

### BACKGROUND OF THE INVENTION

### Description of the Related Technology

Many studies have determined that carbon nanotubes (CNTs) increase the mechanical properties of various systems (e.g., strength, toughness, wear resistance), including polymers. (See Aglan, H., Dennig, P., Ganguli, S., Irvin G. J Reinf Plast Compos 2006, 25, 175; Chen, P., He, J., Hu, G.-H., Zhang, B., Zhang, J., Zhang, Z. Carbon 2006, 44, 692; Esawi, A. M. K., Farag, M. M. Mater Des 2007, 28, 2394; Chen, W., Tao, X., Liu, Y. Compos Sci Technol 2006, 66, 3029; Yaping, Z., Aibo, Z., Qinghua, C., Jiaoxia, Z., Rongchang, N. Mater Sci Eng 2006, 435, 145). In view of these benefits, various techniques have been employed in an attempt to incorporate CNTs into engineering thermosets and thermoplastics, including polyurethanes and epoxies. (See Aglan, H., Dennig, P., Ganguli, S., Irvin G. J Reinf Plast Compos 2006, 25, 175; Curtzwiler, G., Singh, J., Miltz, J., Doi. J., Vorst, K. J Appl Pol Sci 2008, 109, 218).

Carbon nanotubes tend to agglomerate, however. In spite of a neutral net charge on the surface of non-functionalized nanotubes, the molecular electric charge of these nanotubes is not evenly distributed, resulting in momentary dipoles. The momentary dipoles will interact with another molecule if its electric field can reach the other molecule before the dipole disappears. (See Butt, H. J., Graf, K, and Kappl, M., Physics and Chemistry of Interfaces. Wiley and Sons Inc. 2006: Federal Republic of Germany). The average energy of interaction can be found by integrating the potential as a function of all dipole orientations multiplied by the Boltzman probability that each orientation will occur, which is temperature dependent. (See Morrison, Ian and Sydney Ross. Colloidal Dispersion: Suspension, Emulsion, and Foams. Wiley and Sons Inc. 2002: New York, N.Y.). No net charge, little chemical reactivity, and a large surface area leaves only the dispersion forces to determine the long range intermolecular attraction potential. (See Bonard, J. Thin Solid Films 2006, 501, 8). Dispersion forces decrease in magnitude as 1/D (See Curtzwiler, G., Singh, J., Miltz, J., Doi. J., Vorst, K. J Appl Pol Sci 2008, 109, 218), where D is the distance between two molecules, (See Butt, H. J., Graf, K, and Kappl, M., Physics and Chemistry of Interfaces. Wiley and Sons Inc. 2006: Federal Republic of Germany) and have insufficient interaction with the medium to separate the nanotubes. The large surface area combined with insufficient attraction energy with the medium causes the CNTs to agglomerate.

Agglomeration decreases interaction with the host media, hindering the efficiency of stress transfer to the nanotubes. Therefore, in order to enable the nanotubes to better enhance the mechanical attributes of a composite system, it is beneficial to substantially isolate CNTs from one another. Such isolation may be accomplished by first separating agglomerated CNTs and further inhibiting re-agglomeration. Gravity, viscosity, and dispersion forces must also be considered when attempting to isolate and disperse CNTs into a medium as they play a significant role in the stability of dispersions.

Sonication is one method that has been used to help overcome the strong dispersion forces that give rise to agglomeration, allowing isolation of the CNTs. (See Curtzwiler, G., Singh, J., Miltz, J., Doi. J., Vorst, K. J Appl Pol Sci 2008, 109, 218; Wang, X., Xiong, J., Yang, X., Zheng, Z., Zhou, D. Polymer 2006, 47, 1763). When a medium contains particles, the mechanical and thermal properties are altered and the propagation of sound changes. When a sound wave travels though the medium, the resulting motion of the particles produces a pressure wave normal to the direction of the sound scattering the wave. Ultrasonic waves induce a pressure wave normal to the surface of the particle forcing nearby particles apart and allowing for modifications to the system which can increase stability.

Stable suspensions of CNTs require the medium to wet the surface of isolated nanotubes followed by a surface modification to avoid re-agglomeration. Polymer functionalization has proven to introduce sufficient steric repulsion to keep the CNTs isolated during processing, (See Morrison, Ian and Sydney Ross. Colloidal Dispersion: Suspension, Emulsion, and Foams. Wiley and Sons Inc. 2002: New York, N.Y.) and polymeric materials have been widely used for particle stabilization between nano-materials. (See Morrison, Ian and Sydney Ross. Colloidal Dispersion: Suspension, Emulsion, and Foams. Wiley and Sons Inc. 2002: New York, N.Y.; Butt, H. J., Graf, K, and Kappl, M., Physics and Chemistry of Interfaces. Wiley and Sons Inc. 2006: Federal Republic of Germany; Wang, X., Xiong, J., Yang, X., Zheng, Z., Zhou, D. Polymer 2006, 47, 1763; Florian, H., Jacek, N., Zbigniew, R., Karkl, S. Chem Phys Lett 2003, 370, 820; Burghard, M., Surface Sci Rep. 2005, 58, 1; Wu, H., Tong, R., Qiu, X., Yang, H., Lin, Y., Cai, R., Qian, S. Carbon 2007, 45, 152). Adsorption (physisorption) and grafting of polymers are two methods by which such surface modification is accomplished. Adsorption is a non-destructive method to introduce steric stability, as it relies only on Van der Waals forces. Adsorption of polymers to a nanotube surface requires that a portion of the solvent be expelled from the solvated polymer and the surface where the polymer is to be adsorbed. (See Morrison, Ian and Sydney Ross. Colloidal Dispersion: Suspension, Emulsion, and Foams. Wiley and Sons Inc. 2002: New York, N.Y.). The rate at which a polymer adsorbs is directly dependent on the particle-polymer and solvent-polymer interactions as well as the polymer's molecular weight. (See Morrison, Ian and Sydney Ross. Colloidal Dispersion: Suspension, Emulsion, and Foams. Wiley and Sons Inc. 2002: New York, N.Y.).

The additional stability gained by steric repulsion of the particles increases the free energy of the system from the overlap of adsorbed polymer layers. The work required to concentrate the adsorbed polymer as two particles interact determines the stability of the suspension. Concentrating the attached polymers introduces osmotic pressure and reduces the number of configurations for each polymer chain. This decreases the entropy for the system which is thermodynamically unfavorable, thereby forcing the particles to remain separated. (See Morrison, Ian and Sydney Ross. Colloidal Dispersion: Suspension, Emulsion, and Foams. Wiley and Sons Inc. 2002: New York, N.Y.; Butt, H. J., Graf, K, and Kappl, M., Physics and Chemistry of Interfaces. Wiley and Sons Inc. 2006: Federal Republic of Germany).

The magnitude of repulsion provided by the adsorbed polymer is dependent on the compressibility and the thickness of the adsorbed layer. The solvent-polymer interaction will dictate the compressibility of the polymer; a good solvent will yield forces that separate the polymer chains, increasing compressibility, while a bad solvent will cause the polymer chains to attract, decreasing compressibility. Thus, the longer the polymer chain and lower compressibility, the better steric repulsion produced. In practice, the required thickness of the polymer layer is about an order of magnitude less than the radius of the particle. (See Morrison, Ian and Sydney Ross. Colloidal Dispersion: Suspension, Emulsion, and Foams. Wiley and Sons Inc. 2002: New York, N.Y.).

Functionalization by chemical modification is another common approach to add nanotube affinity toward a medium and retain tube isolation once separated. (See Aglan, H., Dennig, P., Ganguli, S., Irvin G. J Reinf Plast Compos 2006, 25, 175; Yaping, Z., Aibo, Z., Qinghua, C., Jiaoxia, Z., Rongchang, N. Mater Sci Eng 2006, 435, 145; Curtzwiler, G., Singh, J., Miltz, J., Doi. J., Vorst, K. J Appl Pol Sci 2008, 109, 218; Florian, H., Jacek, N., Zbigniew, R., Karkl, S. Chem Phys Lett 2003, 370, 820). Many methods have been developed to produce various functional groups on the side wall and caps of nanotubes. (See Burghard, M., Surface Sci Rep. 2005, 58, 1). Polymer grafting has a similar effect as adsorption, except that the polymer chains are chemically (irreversibly) bound to the nanotube wall, rather than attracted to the CNTs by van der Waals forces.

The most common liquid-phase oxidations of carbon nanotubes are refluxing in nitric acid or ultrasonic treatment in a sulfuric/nitric acid mixture. The latter treatment yields shortened tubes covered with carboxyl groups, while the refluxing reaction is milder which reduces the degree of functionalization at the tube ends and defect sites. Oxidative attack at the defect sites leads to local openings of the side wall creating functional groups such as phenols, quinones, lactones, carboxylic anhydrides and acids. Much attention has been paid to functionalization of amide and ester formations based on carboxylic chemistry. (See Burghard, M., Surface Sci Rep. 2005, 58, 1).

Surface initiated polymerization (SIP) is a procedure that allows for control of the polymer functionalization. In this process, the initiating species must adsorb to the surface, create a highly reactive species that can propagate polymerization then react with a monomer to commence the polymerization. (See Butt, H. J., Graf, K, and Kappl, M., Physics and Chemistry of Interfaces. Wiley and Sons Inc. 2006: Federal Republic of Germany). SIP procedures have the advantage of minimally interfering with an elaborate molecular framework that decreases the physical properties of the nanotubes. Wu et al. functionalized multi-walled carbon nanotubes (MWCNTs) with polystyrene via atom transfer radical polymerization to yield functionalities up to 50%. (See Wu, H., Tong, R., Qiu, X., Yang, H., Lin, Y., Cai, R., Qian, S. Carbon 2007, 45, 152). The study suggests that CNTs can be activated by free radical initiators, opening π-bonds for polymerization.

Once nanotubes are suspended in a liquid medium and isolated, various forces may influence the location and motion of the CNTs. Brownian motion distributes particles substantially uniformly through dispersion similar to molecular diffusion of solutes through a solution, except the gravitational force upon the particle is more noticeable. The gravitational force on a particle suspended in a liquid is equal to the effective mass multiplied by the acceleration of gravity. The effective mass of a particle is the product of its volume and the density difference between the particle and the suspending liquid. (See Morrison, Ian and Sydney Ross. Colloidal Dispersion: Suspension, Emulsion, and Foams. Wiley and Sons Inc. 2002: New York, N.Y.). When the gravitational force on a particle is substituted into the terminal velocity equation, there is a quadratic dependence on the radius for the sedimentation rate which describes the importance of particle size for dispersion. The particles in solution eventually reach an equilibrium where Brownian motion and gravitational sedimentation are substantially balanced, resulting in an approximately uniform dispersion. Thermal fluctuations, noise, and mechanical perturbations of the system, as well as the size, density, and shape of the particle, may affect system equilibrium and can be tailored for more favorable interaction between the solvent and the particle. (See Morrison, Ian and Sydney Ross. Colloidal Dispersion: Suspension, Emulsion, and Foams. Wiley and Sons Inc. 2002: New York, N.Y.).

When in motion, the velocity of the nanotubes would increase indefinitely, except the increasing velocity of the particle simultaneously increases the viscous drag resulting in a negative component in the velocity vector slowing it down. (See Morrison, Ian and Sydney Ross. Colloidal Dispersion: Suspension, Emulsion, and Foams. Wiley and Sons Inc. 2002: New York, N.Y.). A particle suspended in a viscous liquid in motion may rapidly attain the velocity of the fluid in the same direction, indicating that shear alignment of the nanoparticles is plausible. When the viscous drag of the particle equals the applied force, terminal velocity of the particle is achieved.

There remains a need for carbon nanotubes with increased mechanical properties and reduced agglomeration. These solutions and other advantages of the present disclosure are discussed in detail below.

### SUMMARY OF THE INVENTION

One embodiment includes a method of continuous fabrication of functionalized carbon nanotubes via free radical linking mechanism. The method includes the steps of selecting a plurality of carbon nanotubes, combining the plurality of carbon nanotubes and unsaturated compounds possessing a functional group capable of chemically binding to a thermosetting matrix wherein the plurality of carbon nanotubes and the unsaturated compound are continuously added into a reaction vessel, and sonicating the carbon nanotubes and the unsaturated compound, wherein the sonicated carbon nanotubes remain substantially separated. In one embodiment, the carbon nanotubes are chemically modified using one of thermo-initiated or sono-initiated free radical polymerization and esterification. In one embodiment, the compounds possessing a functional group are selected from the group consisting of hydroxyethyl methacrylate (HEMA), (meth)acrylic acid, cis-2-butene-1,4, diol, maleamic acid, maleic anhydride and combinations thereof. In some embodiments, the sonication can include continuous sonication. In some embodiments, the sonication can include pulse sonication. In some embodiments, the functional group can be an alcohol, acid, amide, anhydride group or combinations thereof. In some embodiments, the reaction solution can be temperature controlled during the sonication process.

Another embodiment includes a method for continuously forming functionalized carbon nanotubes, the method comprising selecting a plurality of carbon nanotubes, combining the carbon nanotubes and one or more unsaturated compounds comprising a functional group to undergo thermo-initiated or sono-initiated free radical surface polymerization reaction wherein the carbon nanotubes and the unsaturated compound are continuously fed into a reaction vessel, combining the carbon nanotube and the unsaturated compound with a catalyst selected from the group consisting of aromatic peroxide compounds or azo compounds to form a carbon nanotube mixture, and subjecting the carbon nanotube mixture to sonication. In one embodiment, a method also includes the step of heating the functionalized carbon nanotube mixture. In one embodiment, the carbon nanotubes are acid purified. In some embodiments, the azo compound can be 4,4′-azobis(cyanovaleric acid) or azobisisobutyronitrile.

Yet in another embodiment, the concentration of the unsaturated compound in solution is in the range between about 25 to 100 vol. %. In one embodiment, the catalyst comprises an aromatic radical producing species, and the concentration of the catalyst added to the carbon nanotube-HEMA mixture is in the range of between about 0.5 to 10 mg of initiating species/ml solution. In one embodiment, the aromatic peroxide compound is benzoyl peroxide (BPO).

In one embodiment, the sonication is performed using ultrasonic frequencies ranging between about 10 to 100 kHz at about 600 W and an amplitude ranging from about 100 to 300 μm for between about one to sixty minutes. Another embodiment includes the step of heating the mixture at temperatures ranging between about ±20° C. of the activation temperature of the initiating species for about 10 to 60 min to facilitate functionalization of the carbon nanotubes with HEMA.

Yet another embodiment includes a method for isolating carbon nanotubes, the method comprising selecting a plurality of carbon nanotubes, acid purifying the carbon nanotubes, combining the carbon nanotubes and one or more unsaturated compounds comprising a functional group as described above to undergo thermo-initiated or sono-initiated free radical surface polymerization reaction, wherein the unsaturated compound is selected from the group consisting of hydroxyethyl methacrylate (HEMA), cis-2-butene-1,4-diol, and other compounds with nucleophilic or electrophilic functional groups wherein the carbon nanotubes and the unsaturated compound are continuously fed into a reaction vessel, combining the carbon nanotube and the unsaturated compound with a catalyst selected from the group consisting of compounds with esterification capabilities to form a carbon nanotube mixture, and sonicating the carbon nanotubes mixture to form functionalized carbon nanotubes, wherein the functionalized carbon nanotubes remain separated and do not substantially re-agglomerate. In one method, the carbon nanotubes are selected from the group consisting of multi-walled carbon nanotubes (MWNTs), single-walled carbon nanotubes (SWNTs), double-walled carbon nanotubes (DWNTs) and few-walled carbon nanotubes (FWNTs).

In yet another method, the catalyst is one of HfCl₄-2THF and ZrCl₄-2THF, and the amount added to the carbon nanotube HEMA mixture is less than about 0.2 wt. %.

In another embodiment, sonication is performed using ultrasonic frequencies ranging between about 10 to 100 kHz at about 600 W and an amplitude ranging from about 100 to 300 μm for between about one to sixty minutes. In yet another embodiment, the method further includes the step of heating the mixture at temperatures ranging between about ±20° C. of the activation temperature of the initiating species for about 10 to 6 min to facilitate functionalization of the carbon nanotubes with HEMA.

One embodiment includes a coating system comprising a polymer base and the functionalized nanotube made according to methods described herein. In one embodiment, the coating system is a polymer base selected from the group consisting of polyurethanes, epoxies, polyester resins, and any thermoplastics with similar polarity as the functionalizing species.

One embodiment comprises a carbon nanotube functionalized by the methods described herein.

One embodiment comprises sonicating the functionalized carbon nanotubes.

### BRIEF DESCRIPTION OF THE DRAWINGS

FIG. 1A is a flow diagram illustrating one embodiment of a method of forming functionalized carbon nanotubes (CNTs) by free radical polymerization.

FIG. 1B is a flow diagram illustrating one embodiment of a method of forming functionalized carbon nanotubes (CNTs) by esterification.

FIG. 2 is a schematic illustration of a free radical functionalization reaction for CNTs.

FIG. 3 is a flow diagram illustrating one embodiment of a method of incorporating functionalized CNTs into a coating system.

FIG. 4 is an absorbance plot of an embodiment of hydroxyethyl methacrylate (HEMA) functionalized-MWCNTs (multi-walled carbon nanotubes) of the present disclosure, attenuated total reflectance-Fourier transform infrared spectroscopy (ATR-FTIR).

FIG. 5 is an absorbance plot of an embodiment of a HEMA-MWCNT polyurethane coating (HEMA-MWCNT-PU) and a neat polyurethane coating (PU), as measured by ATR-FTIR.

FIGS. 6A and 6B are optical micrographs (about 100×) of embodiments of HEMA-MWCNT polyurethane coatings in as-fabricated (6A) and sheared (6B) conditions.

FIG. 7A is an Atomic Force Microscope (AFM) image of an isolated carbon nanotube in a 2-component polyurethane coating in the as-fabricated condition without shear.

FIG. 7B is an AFM image of carbon nanotubes in a 2-component polyurethane coating in the sheared condition.

FIG. 8 is a flow diagram illustrating one embodiment of a method of continuously forming functionalized carbon nanotubes (CNTs) by free radical polymerization.

### DETAILED DESCRIPTION

Embodiments of the present disclosure illustrate systems and methods for the separation of carbon nanotubes (CNTs) in solution and continuous fabrication of functionalized carbon nanotubes (CNTs). The method of continuous fabrication of functionalized carbon nanotubes can be achieved via a free radical linking mechanism. The chemical functionalization can include various polymerizations including using an initiating species which can adsorb to the surface and create a highly reactive species that can propagate polymerization. Examples of the initiating species include, for example, radical, cation, anion, carboxylic acid, alcohol, and amine, depending on the polymerization mechanism.

In certain embodiments, the CNTs are isolated by sonication and chemical modification of the CNTs using functionalization reactions, including thermo-initiated or sono-initiated free radical polymerization and esterification. Beneficially, sonication facilitates mechanical separation of the CNTs, while the chemical modification of the CNTs results in more favorable interactions between the CNTs and their surrounding media which enables the separated CNTs to remain isolated. Embodiments of the isolated CNTs can be employed into material matrices. As used herein, “separated” or “substantially separated” refers to a stable dispersion of de-agglomerated functionalized nanotubes.

In certain embodiments, the chemical functionalization can be performed using unsaturated compounds possessing a functional group. The functional group can be selected from an alcohol, acid, amide, anhydride group or combinations thereof. The functional group can be a nucleophilic or an electrophilic functional group. Examples of such compounds include, but are not limited to, hydroxyethyl methacrylate (HEMA) and cis-2-butene-1,4, diol, (meth)acrylic acid, maleamic acid, maleic anhydride and combinations thereof.

The functional group can chemically bind to a thermosetting matrix. As used herein, “thermosetting matrix” refers to a matrix or a material that can become reactive upon heating. Examples of the thermosetting matrix can include but are not limited to polyurethanes, epoxies, and polyester resins.

In some embodiments, the temperature of the carbon nanotube and the unsaturated compound can be controlled during the modifying step. In some embodiments, the temperature of the carbon nanotube and the unsaturated compound can be controlled during the sonicating step.

The ultrasonic frequencies of the sonication can be adjusted depending on the type of functionalized carbon nanotubes. In some embodiments, the sonication is performed using ultrasonic frequencies in a range from about 10 to 100 kHz at about 600 W. In some embodiments, the sonication is performed using ultrasonic frequencies in a range from about 10 to 50 kHz at about 600 W. In some embodiments, the sonication is performed using ultrasonic frequencies in a range from about 10 to 30 kHz at about 600 W.

The amplitude of the sonication can be adjusted depending on the type of functionalized carbon nanotubes to be fabricated. In some embodiments, the amplitude of the sonication is in a range from about 100 to 300 μm for between about one to sixty minutes. In some embodiments, the amplitude of the sonication is in a range from about 100 to 300 μm for between about one to twenty minutes. In some embodiments, the amplitude of the sonication is in a range from about 100 to 300 μm for between about one to ten minutes. In some embodiments, the amplitude of the sonication is in a range from about 100 to 300 μm for between about one to three minutes.

The temperature at which the reaction mixture is heated can be adjusted. In some embodiments, the reaction mixture is heated at temperatures ranging between about ±20° C. of the activation temperature of the initiating species to facilitate functionalization of the carbon nanotubes. In some embodiments, the reaction mixture can be heated at temperatures ranging between about ±40° C. of the activation temperature of the initiating species to facilitate functionalization of the carbon nanotubes. In some embodiments, the reaction mixture can be heated at temperatures ranging between about ±60° C. of the activation temperature of the initiating species to facilitate functionalization of the carbon nanotubes. In some embodiments, the reaction mixture can be heated at temperatures ranging between about ±80° C. of the activation temperature of the initiating species to facilitate functionalization of the carbon nanotubes. In some embodiments, the reaction mixture can be heated at a temperature in a range of from about 50° C. to about 200° C. In some embodiments, the reaction mixture can be heated at a temperature in a range of from about 80° C. to about 150° C. In some embodiments, the reaction mixture can be heated at a temperature in a range of from about 100° C. to about 150° C.

The duration for which the reaction mixture is heated can also be adjusted depending on the type of functionalized carbon nanotube. In some embodiments, the reaction mixture can be heated for about 10 minutes to about 100 minutes. In some embodiments, the reaction mixture can be heated for about 10 minutes to about 60 minutes. In some embodiments, the reaction mixture can be heated for about 10 minutes to about 30 minutes.

Some major advantages of the above methodology include that the materials and procedures mentioned above are relatively less hazardous, cheaper, and easier than other types of functionalizations found in the literature and in practice. These and other advantages of the present disclosure are discussed in detail below.

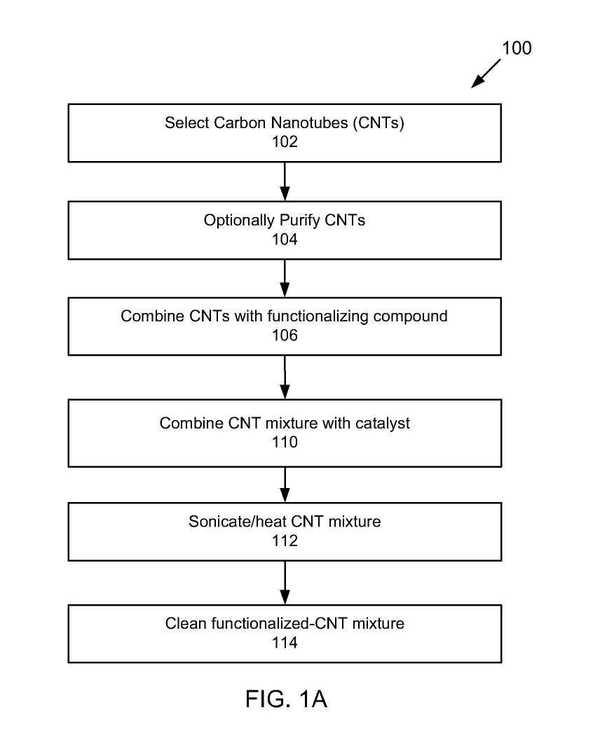

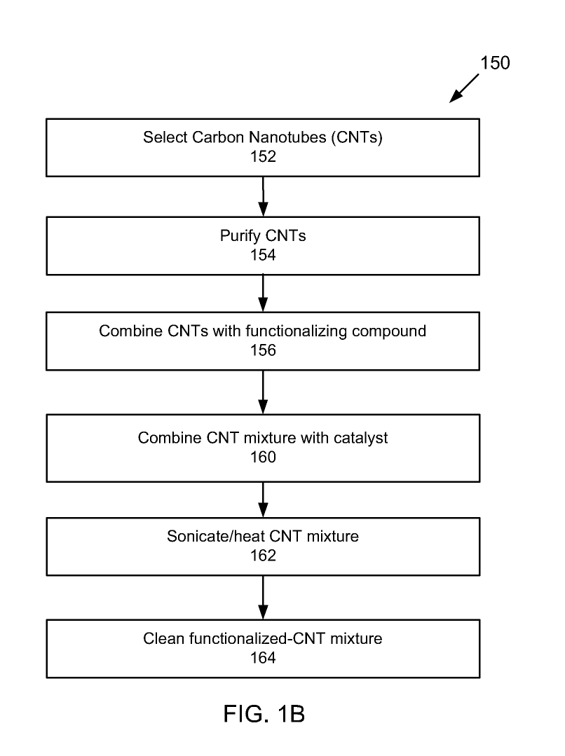

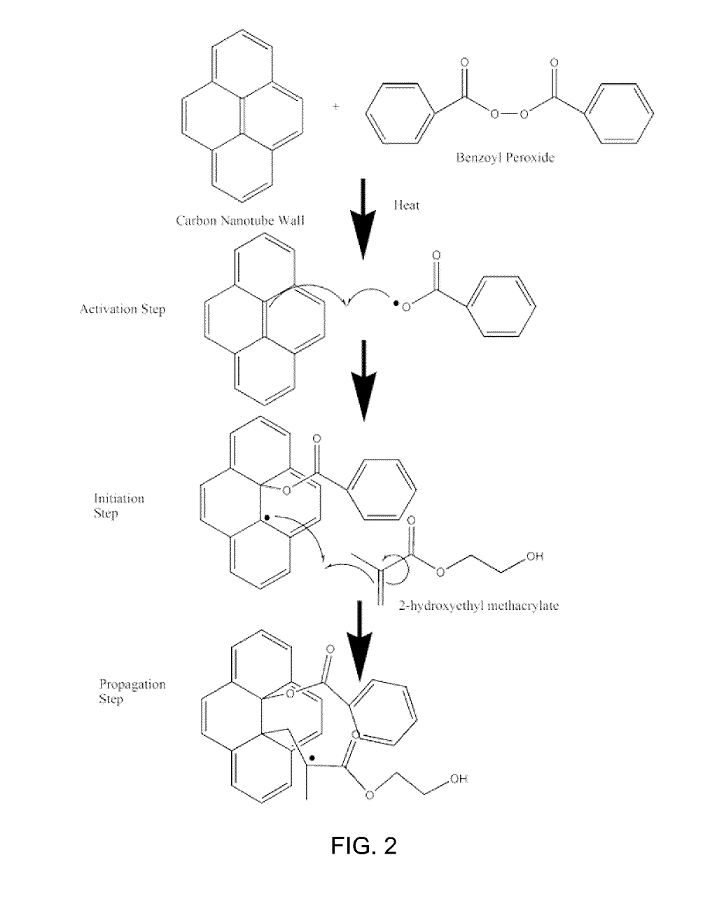

FIG. 1A is a flow diagram illustrating one embodiment of a method 100 for functionalization of carbon nanotubes by thermo-initiated or sono-initiated free radical surface polymerization. An illustrative schematic embodiment of functionalization employing HEMA is illustrated in FIG. 2. It will be understood that the method 100 can include greater or fewer processes and can be performed in any order, as necessary.

The method begins in block 102, where carbon nanotubes are selected. In certain embodiments, the carbon nanotubes comprise multi-walled carbon nanotubes (MWNTs). In alternative embodiments, the carbon nanotubes comprise single-walled carbon nanotubes (SWNTs), double-walled carbon nanotubes (DWNTs) or few-walled carbon nanotubes (FWNTs).

In block 104, the CNTs are optionally purified. In certain embodiments, the CNTs are acid purified. In alternative embodiments, acid purified CNTs are purchased and the acid purification process can omitted.

In block 106, the CNTs are combined with one or more functionalizing compounds. In certain embodiments, the free radical polymerization is performed by reaction between unsaturated compounds possessing an alcohol functional group and the CNTs. Examples of the functionalizing compound include, but are not limited to, HEMA, cis-2-butene-1,4-diol, and other compounds with nucleophilic or and unsaturated functional groups. It will be appreciated that HEMA and cis-2-butene-1,4-diol are exemplary compounds; however, any compound possessing these chemical functionalities are also contemplated. The reaction can be performed in solvents including, but not limited to, tetrahydrofuran (THE), methanol, acetone, 2-heptanone, and other solvents in which the reactive species and functionalizing compound are soluble. The concentration of the functionalizing compounds in solution can range between about 25 to 100 vol. %.

A catalyst can be further added to the CNT mixture in block 110. The concentration of the catalyst added to the CNT-HEMA mixture can range between about 0.01 to 250 mg/ml of initiating species/mL solution.

Suitable catalysts include benzoyl peroxide (BPO), methyl ethyl ketone peroxide (MEKP), acetone peroxide, 4,4′-azobis(cyanovaleric acid), and other aromatic and aliphatic peroxide compounds. In certain embodiments, the catalyst can be further placed into solution with one or more solvents prior to addition to the CNT-HEMA mixture.

To facilitate isolation of the CNTs, the CNT-HEMA mixture is sonicated and/or heated in block 112. Prior to sonication, the mixture can be purged with an inert gas, such as nitrogen or argon, to displace atmospheric oxygen. Sonication is preferably performed using ultrasonic frequencies ranging from between about 10 to 100 kHz at about 600 W and an amplitude ranging from about 100 to 300 μm for between about one to sixty minutes. Following sonication, the mixture is further heated at temperatures ranging between about ±20° C. of the activation temperature of the initiating species for about 10 to 60 min to facilitate functionalization of the CNTs with HEMA. The sonication and heating can be alternated, as necessary.

In block 114, the resultant HEMA-functionalized CNTs are cleaned by washing with solvents. Examples of solvents include THF, methanol, 2-heptanone, or other solvents in which the monomer and initiating species are soluble, and combinations thereof. Sonication and/or centrifugation can be further employed to facilitate washing. Following centrifugation, the supernatant is decanted and the HEMA-functionalized are CNTs re-suspended in fresh solvent by sonication as discussed above prior to further use.

FIG. 1B is an alternative embodiment of a method 150 for functionalization of carbon nanotubes by esterification. It will be understood that the method 150 can include greater or fewer processes and can be performed in any order, as necessary.

The method begins in block 152, where carbon nanotubes are selected. In certain embodiments, the carbon nanotubes comprise multi-walled carbon nanotubes (MWNTs). In alternative embodiments, the carbon nanotubes comprise single-walled carbon nanotubes (SWNTs), double-walled carbon nanotubes (DWNTs) and/or few-walled carbon nanotubes (FWNTs).

In block 154, the CNTs are purified. In certain embodiments, the CNTs are acid purified. In alternative embodiments, acid purified CNTs are purchased for use and the acid purification process can be omitted.

In block 156, the CNTs are combined with one or more functionalizing compounds. In certain embodiments, the chemical modification is performed by reaction between di-functional or greater compounds with esterification capabilities and the CNTs. Examples of the functionalizing compound include, but are not limited to, HEMA, cis-2-butene-1,4-diol, and other compounds with nucleophilic or electrophilic and unsaturated functional groups. The reaction is preferably performed in solvents such as o-xylene, mesitylene, and other solvents in which the reactive species and functionalizing compound are soluble.

In block 160, the CNTs are combined with one or more functionalizing compounds. In certain embodiments, the esterification is performed by reaction between di-functional or greater compounds with esterification capabilities and the CNTs. To a mixing vessel containing the CNTs is added the functionalizing compound (e.g., adipic acid, glycols, terephthalic acid, hexamethylene diamine, and the like).

In block 160, a catalyst can be further added to the CNT mixture. The concentration of the catalyst added to the CNT-HEMA mixture is preferably less than about 0.2 wt. %. Examples of the catalyst include, but are not limited to, HfCl₄-2THF, ZrCl₄-2THF, and other catalysts with the esterification capabilities.

To facilitate isolation of the CNTs, the CNT-HEMA mixture can be sonicated and/or heated in block 162. Prior to sonication, the mixture is purged with an inert gas, such as nitrogen, to displace atmospheric oxygen. Sonication is performed using ultrasonic frequencies ranging between about 10 to 100 kHz at about 600 W and an amplitude ranging from about 100 to 300 μm for between about one to sixty minutes. Following sonication, the mixture can be further heated at temperatures ranging between about ±20° C. of the activation temperature of the initiating species for about 10 to 60 min to facilitate functionalization of the CNTs with HEMA. The sonication and heating can be alternated, as necessary.

In block 164, the resultant HEMA-functionalized CNTs are cleaned by washing with solvents. Examples of solvents include THF, methanol, 2-heptanone, or other solvents in which the monomer and initiating species are soluble, and combinations thereof. Sonication and/or centrifugation can be further employed to facilitate washing. Following centrifugation, the supernatant is decanted and the HEMA-functionalized CNTs are re-suspended in fresh solvent by sonication as discussed above prior to further use.

In FIG. 2, the activation step consists of adding heat to the carbon nanotube/BPO mixture. During the activation step, the BPO decomposes to create two free radicals. One free radical subsequently reacts with the double bonds located on the carbon nanotube wall. The reaction opens the double bond and leaving an active free radical on the side wall of the carbon nanotube. SIP is initiated when the free radical on the carbon nanotube reacts with the double bond on the monomer which creates another free radical on the monomer that allows for polymer propagation.

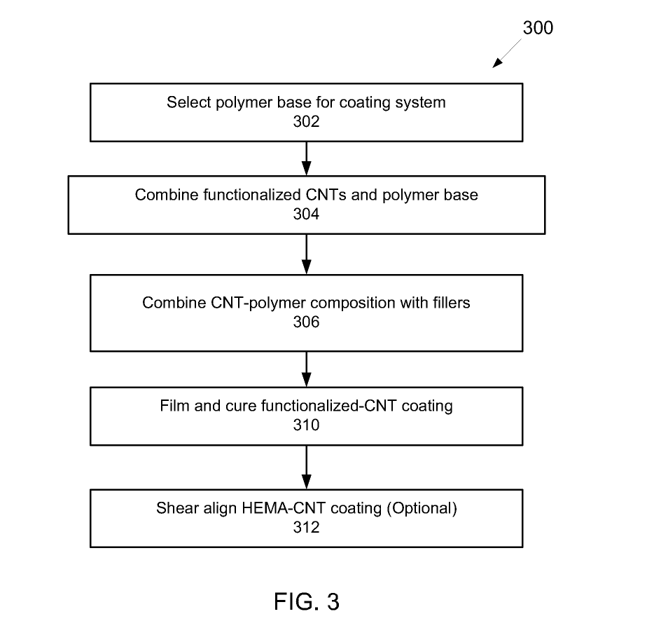

FIG. 3 is a flow diagram of an embodiment of a method 300 for incorporation of HEMA-functionalized CNTs in a coating system. In block 302, a coating system is selected. In certain embodiments, the coating system is a multi-component system.

In one example, the coating system comprises a polymer base and the carbon nanotubes which have been substantially dispersed as discussed above. Examples of polymer bases include, but are not limited to, polyurethanes, epoxies, polyester resins, and any thermoplastics with similar polarity or miscibility as the functionalizing species.

In certain embodiments, the polymer base comprises multiple components. For example, polyurethanes can comprise at least two components, each of which can comprise multiple compounds. In an embodiment, one component can act as a resin, while the other component can act as a hardener.

In block 304, the functionalized CNTs are added to the polymer base. In block 306, additional fillers can also be added to the composition, as necessary. The CNT-polymer composition is preferably mixed at a temperature of from about 10° C. to about 200° C. until a substantially uniform composition is achieved. The mixing temperature of the CNT-polymer composition can vary depending on the viscosity of the resin or hardener and subsequent curing reaction temperature. In some embodiments, the CNT-polymer composition can be mixed at a temperature from about 10° C. to about 250° C. In some embodiments, the CNT-polymer composition can be mixed at a temperature from about 50° C. to about 200° C. In some embodiments, the CNT-polymer composition can be mixed at a temperature from about 10° C. to about 150° C. In some embodiments, the CNT-polymer composition can be mixed at a temperature from about 50° C. to about 150° C.

In block 310, the functionalized-CNT composition is cured. In certain embodiments, the composition is deposited on a substrate in a selected thickness prior to curing. The thickness of the substrate is determined at least in part by the polymer resin system. Deposition processes can include, but are not limited to, spin coating, gravity leveling, spray coating, vacuum infusion, and any other method for producing finished parts with a 2-component system or thermoplastic. The composition is then cured at temperatures ranging between about 10 to 250° C. for between about 1 minute to 14 days.

The functionalized CNT composition can be optionally shear aligned. In block 312, the functionalized-CNT composition is further shear aligned. Shear alignment of the CNTs allows for increased strength in one direction and further aids in producing more predictable mechanical properties throughout the composite. Shear can be introduced to the system via methods including, but not limited to, extrusion, spray application, and injection molding.

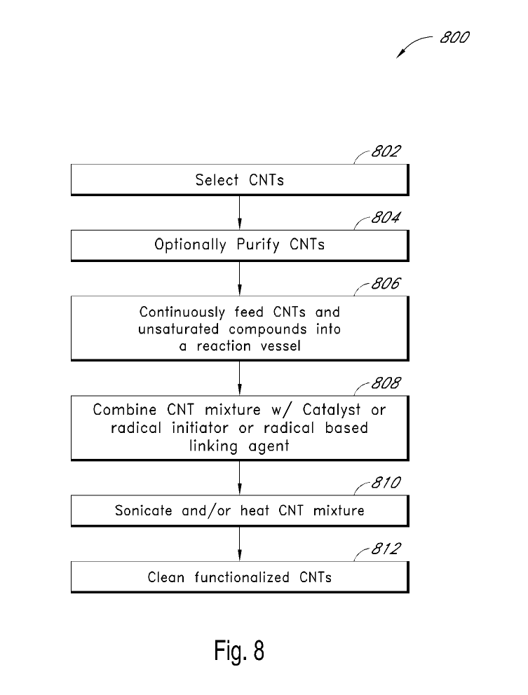

FIG. 8 is a flow diagram of an example of a continuous fabrication of the functionalized CNTs. It will be understood that the method of 800 can include greater or fewer processes and can be performed in any order, as necessary.

The method begins in block 802, where CNTs are selected. In some embodiments, the carbon nanotubes can comprise MWCNTs. In other embodiments, the carbon nanotubes can comprise single-walled carbon nanotubes, double-walled nanotubes, or few-walled carbon nanotubes.

In block 804, the CNTs are optionally purified. In some embodiments, the CNTs are acid purified. In other embodiments, the purified CNTs can be purchased and the purification step can be omitted.

In block 806, the CNTs and the unsaturated compound can be continuously fed into a reaction vessel. For example, the CNTs can be loaded in the container A, and a mixture of the monomer and solvent can be loaded into the container B; Containers A and B can be continuously flushed with nitrogen or another inert gas to expel oxygen; the CNTs in container A and the monomer in container B are continuously fed into a sonication tank.

The monomer can be an unsaturated compound having at least one functional group. The functional group can be a nucleophilic or electrophilic functional group. Examples of an unsaturated compound include but are not limited to hydroxyethyl methacrylate (HEMA), cis-2-butene-1,4-diol, and other compounds with one or more nucleophilic or electrophilic functional group.

The CNTs and the unsaturated compound can be sonicated before reaching the reaction vessel. Containers A and B can be equipped with one or more tip sonicator. Containers A and B can also be equipped with one or more intermittent sonicators.

In some embodiments, the CNT and the unsaturated compound can be sonicated prior to the addition of the catalyst/initiator. In some embodiments, the CNT and the unsaturated compound can be sonicated in the presence of the catalyst/initiator. The functionalized CNTs can be formed after the addition of the catalyst/initiator.

After the CNT, the unsaturated compound, and the catalyst/initiator are combined to form a reaction mixture, the reaction mixture can be sonicated continuously or in pulse. In some embodiments, the reaction mixture is sonicated.

The temperature of the reaction mixture can be controlled during the sonication process. In some embodiments, the temperature of the reaction mixture can be controlled in a range of between about ±20° C. of the activation temperature of the catalyst/initiator for about 10 to 60 min to facilitate functionalization of the carbon nanotubes with the unsaturated compound.

The mixture of the CNTs, the unsaturated compound, and the solvent can undergo sonication before reaching the reaction vessel. The mixture of the CNTs and the unsaturated compound can be first mixed in a sonication tank before being pumped into a reaction vessel.

In block 808, a catalyst can be further added to the mixture of CNTs and unsaturated compound. The concentration of the catalyst added to the mixture of the CNTs and the unsaturated compound can be determined by the reaction conditions such as the concentration and the type of unsaturated compound used.

In block 810, the mixture of CNTs and unsaturated compound can be sonicated and/or heated. Prior to sonication, the mixture is continuously purged with an inert gas, such as nitrogen, to displace atmospheric oxygen. Sonication can be performed using ultrasonic frequencies ranging between about 10 to 100 kHz at about 600 W and an amplitude ranging from about 100 to 300 μm for between about one to sixty minutes. Following sonication, the mixture can be further heated at temperatures ranging from between about ±20° C. of the activation temperature of the initiating species for about 10 to 60 min to facilitate functionalization of the CNTs with the unsaturated compound. The sonication and heating can be alternated, as necessary.

The reaction vessel can be equipped with multiple tip sonicators. The reaction vessel can be equipped with one or more intermittent sonicators. In some embodiments, the sonication includes continuous sonication. In other embodiments, the sonication includes pulse sonication. The use of pulse sonication or continuous sonication can depend on the physical properties of the CNTs (i.e. length, diameter, and degree of CNT entanglement) and can be optimized to maximize the exfoliation and degree of chemical functionalization desired. The amount of CNTs added and the amount of the unsaturated compound added can be determined based on the desired molecular weight and grafting density of the polymer. The flow rate of container A and container B can be controlled to achieve a predetermined ratio of the CNTs and the unsaturated compound. The temperature at which the CNTs and the unsaturated compound are heated can also be controlled.

The reaction vessel can include a bath sonicator or intermittent tip sonicator, a heating component to heat high enough to activate the catalyst, and metal tubing within the sonication chamber. The reaction vessel can be similar to a reactive extruder with the mechanism for placing a tip sonicator. The initiator/catalyst can be combined with the CNT and unsaturated monomer mixture prior to the reaction vessel. The reaction mixture can be removed from the reaction vessel once it is determined that the reaction between CNTs and the unsaturated compound is complete and the desired functionalized CNTs have been formed. In block 812, the resulting functionalized CNTs are cleaned by washing with solvents.

The length and flow of the reaction chamber can depend on the desired functionality of the CNTs and molecular weight of the grown polymer. To reduce the time in the reaction vessel, it is possible to attach oligomeric vinyl monomers to the MWCNTs through a “grafting to” approach and the use of reversibly terminating radical molecules such as nitroxides, RAFT agent, or ATRP type systems. In the “grafting to” approach, a reactive moiety can be chemically bound to the MWCNT followed by a chemical reaction that chemically links the reactive moiety to the oligomeric polymer. Towards the end of the reaction chamber, antioxidants or nitroxides can be added to neutralize any remaining free radicals. The functionalized CNT mixture is cooled to help terminate the reaction. The cooling temperature can be modified to increase solubility of the CNTS and decrease viscosity of the solution.

In comparison of the batch production of functionalized CNTs, the continuous process of making the functionalized CNTs reduces the functionalization time to create a more economically viable process for functionalizing CNTs. In addition, the continuous fabrication described herein has other advantages because the system synthesizes functionalized CNTs of quality comparable or superior properties to those synthesized by the batch process at reduced cost due to the ability of large scale production.

The continuous process can also be used to in combination with the batch production process to produce functionalized MWCNTs with desired properties.

### EXAMPLES

In the examples below, HEMA-functionalized CNTs and coatings formed therefrom are discussed in detail. These examples are discussed for illustrative purposes and should not be construed to limit the scope of the disclosed embodiments.

Unbundled, multi-walled carbon nanotubes (MWCNTs) were employed for functionalization in the as-received condition (Ahwahnee Technology). All chemicals used for SIP and the production of the polyurethane coating were used as received from the manufacturer.

### Example 1

### HEMA Functionalization of MWCNTs

About 85 mg of MWCNTs were added to about 10 mL of an approximately 50 vol. % hydroxyethyl methacrylate (HEMA) (Rocryl 400 monomer, Rohm and Haas)/tetrahydrofuran (THF) solution in an approximately 25 mL round bottom flask. A magnetic stir bar was placed in the flask, which was then covered with a rubber septum. An approximately 0.25 inch diameter, tapered tip sonication horn was inserted through the septum until the tip of the horn was submerged in the liquid, providing a substantially air tight seal.

About 15 mg of benzoyl peroxide (BPO) catalyst having a purity greater than about 97% (Aldrich) were dissolved in approximately 0.5 mL of THF. The BPO/THF solution was injected through the septum into the CNT/HEMA/THF mixture. The system was purged with nitrogen for about 15 min to expel atmospheric oxygen.

The mixture was then sonicated with an ultrasonic generator (Heat systems Ultrasonic Processor XL) equipped with an approximately 0.25 inch tapered horn on level 5 (about 20 kHz at about 110 μm amplitude) for about 1 minute, then placed in an oil bath at approximately 80° C. The mixture was removed from heat about every five minutes to sonicate the mixture for 30 seconds then returned to heat until the reaction was terminated after 20 minutes.

The resulting, highly viscous liquid was washed via four cycles: three times with an approximately 50 vol. % solution of THF/methanol three times, then once more with 2-heptanone. A wash cycle included sonicating for about 30 seconds in the washing solvent, followed by about 10 minutes of centrifugation at about 4000 rpm. The supernantant was decanted off into a glass bottle and the pellet was re-suspended in fresh solvent via tip sonication for 30 seconds using the same settings as before. The functionalized CNTs from the sediment were sonicated in 2-heptanone for about 30 seconds before addition to the coating formulation.

The HEMA-MWCNT composition, after functionalization, was found to be substantially uniformly black and highly viscous. This result indicates that the SIP HEMA polymerization was successful. Furthermore, the result also suggests that a high level of dispersion and affinity for the solvent mixture was achieved. The supernatant after centrifugation of each wash was also uniformly black, indicating, the presence of isolated tubes with a strong affinity for the wash solvent.

### Example 2

### Incorporation of HEMA-Functionalized MWCNTs in a 2K Polyurethane Coating

The HEMA-functionalized MWCNTs in 2-heptanone were added to part A of a 2-component polyurethane coating in an amount which would provide a final HEMA-CNT concentration of about 1 wt. % concentration in the cured coating. The HEMA-CNT-polyurethane composition was mixed by hand for about 2 min then allowed to sit for about 20 minutes. Subsequently, Part A was added to part B in an approximately 4:1 ratio, mixed by hand until there was a visually uniform viscosity then allowed to sit for about 20 minutes.

The mixture was placed on a glass slide via plastic transfer pipette, allowed to level by gravity, then placed in an oven for about 1 hour at about 70° C. Two drawdowns were also produced using an approximately 37 micron drawdown cube at a moderate speed then placed in an oven for about 1 hour at about 70° C.

Part A of the polyurethane coating comprised about 58.7 wt. % Joncryl 910 acrylic polyol (BASF), about 25.9 wt % 2-heptanone (about 98% purity, Acros Organics), about 8.11 wt. % hexanes (Histological grade, Fisher Scientific), about 5.90 wt % n-pentyl propionate (>99% purity, Aldrich), about 0.60 wt. % Tinurin 292 (Ciba Specialty Chemicals), about 0.40 wt. % Tinurin 1130 (Ciba Specialty Chemicals), and about 0.30 wt. % Byk 315 (Byk Chemie) with about 41.7 wt % solids. Part B of the coating comprised about 54.5 wt. % Desmodur N3300A isocyanates (Bayer Material Science), and about 45.5 wt. % n-butyl acetate (Acros Organics) with about 54.4 wt. % solids.

### Example 3

### Infrared Spectroscopy Analysis

Attenuated Total Reflectance Fourier Transform Infrared Spectroscopy (ATR-FTIR) was used to qualitatively determine the presence of various functional groups in HEMA-MWCNT polyurethane composites (HEMA-MWCNT-PU) and a control system comprising the neat polyurethane alone (PU). A Smart Performer ATR assembly (Thermo Scientific) attached to a Nexus 470 Fourier Transform Infrared Spectrometer (Nicolet Instruments) scanned specimens at 32 scans per experiment. A background scan was performed before the evaluation of all specimens. Each coating type was placed on the crystal at about ambient temperature after the curing process. The washed HEMA-MWCNTs were placed in a glass jar and heated at about 50° C. in an oven until the solvent was substantially evaporated then placed on the ATR assembly and scanned.

Infrared spectroscopy experiments were conducted on functionalized HEMA-MWCNTs and coatings of neat polyurethane and polyurethane incorporating HEMA-MWCNTs. Three experiments were performed on each system for evaluation of molecular composition by Attenuated Total Reflectance Fourier Transform-Infrared Spectroscopy (ATR-FTIR).

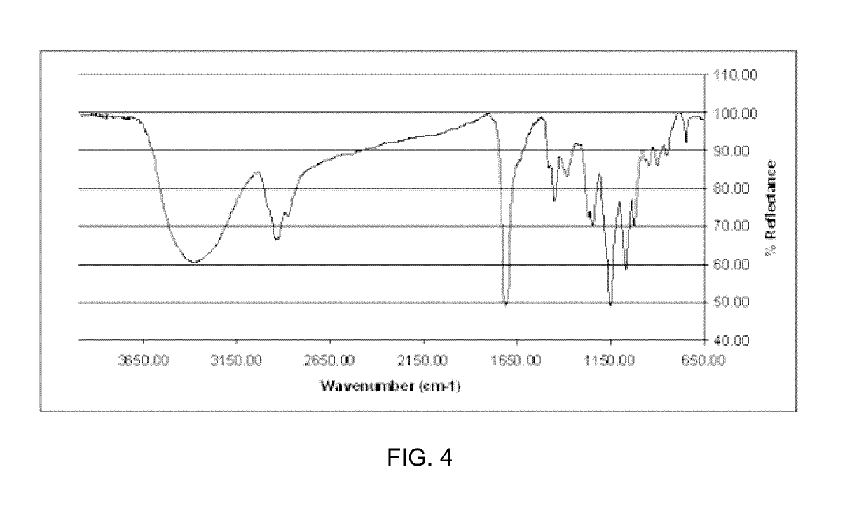

FIG. 4 illustrates a representative absorbance spectrum obtained from ATR-FTIR examination of HEMA-functionalized MWCNTs alone. The spectra were compared against the Sprouse Polymer ATR library and had an approximately 92% correlation with the reference spectra for poly(hydroxyethyl methacrylate), indicating that polymerization was successful.

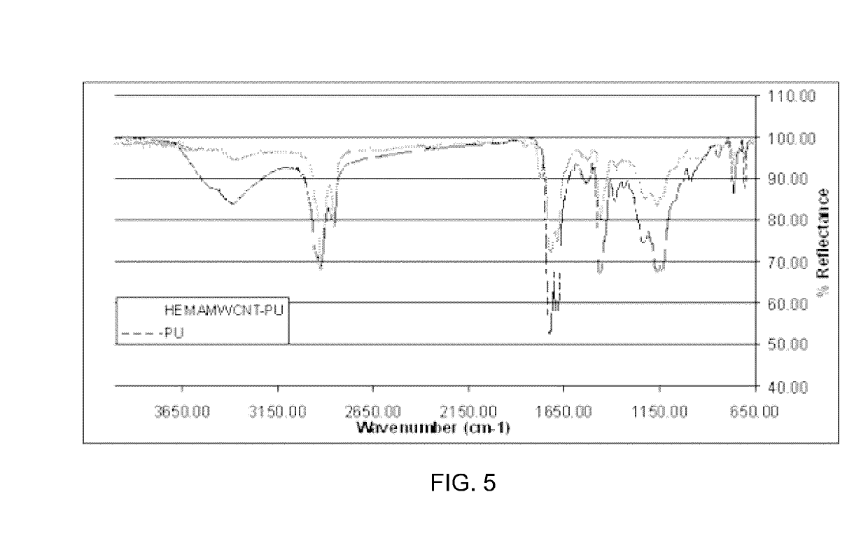

FIG. 5 illustrates representative absorbance spectra obtained from ATR-FTIR for coatings of neat polyurethane coatings and polyurethane coatings incorporating HEMA-MWCNTs. The absorbance behavior observed in the infrared region indicates that molecular composition does not substantially change when the HEMA-MWCNTs are added to the PU coating. The signals at about 3376, 1719, 1531, and 1230 cm⁻¹ can be attributed to the NH stretch, C═O stretch, NH bend, and CO stretch, respectively. (See Koinkar, N., Bhushan, B., Effect of scan size and surface roughness on micro-scale friction measurements. Journal of Applied Physics. 81 (1997) 2472-2479; Bonilla, Jose., Lobo, Hubert. Handbook of Plastics Analysis. Marcel Dekker 2003).

### Example 4

### Differential Scanning Calorimetry

Differential Scanning calorimetry (DSC) experiments were conducted in order to evaluate the glass transition temperature (T_{g}) at different rates of heating/cooling cycles.

About 3-5 mg of the HEMA-functionalized MWCNTs and each coating (HEMA-functionalized MWCNT/PU coating and PU coating) were placed in separate aluminum pans and hermetically sealed. The glass transition temperature of each coating and the functionalized MWCNTs were evaluated on a calorimeter (DSCQ1000, TA Instruments, DE). The HEMA-MWCNT experiments were conducted in accordance with ASTM D3418-03 for the determination of the glass transition temperature, with a heat/cool/heat cycle of between about 20 and 150° C. at a rate of about 10° C./min for the first heat cycle, about 10° C./min for the cooling cycle, and about 20° C./min for the second heat cycle. The experiments for the coatings employed the same heating/cooling rates as the HEMA-MWCNTs testing, but were conducted between about −50 and 150° C.

DSC measurements were made for three specimens per coating type and HEMA-MWCNT and the testing results are summarized in Table 1 below:

TABLE 1
The Glass Transition Temperatures (T_{g}) of HEMA-MWCNT,
PU Coating, and HEMA-MWCNT/PU Coating^{z}

| | T_{g} 10° C./min | T_{g} 10° C./min | T_{g} 20° C./min |
|---|---|---|---|
| Sample | (Heat) | (Cool) | (Heat) |
| HEMA-MWCNT | 48.23 a | 39.43 a | 62.19 a |
| HEMA-MWCNT/PU | 35.60 ab | 29.13 a | 40.66 b |
| Coating | | | |
| PU Coating | 37.77 ab | 28.47 a | 42.06 b |
| P value | 0.024 | 0.080 | 0.004 |

^{z}Samples with the same letter in a column were not found to be significantly different using Tukey's 95% Simultaneous Confidence Interval.

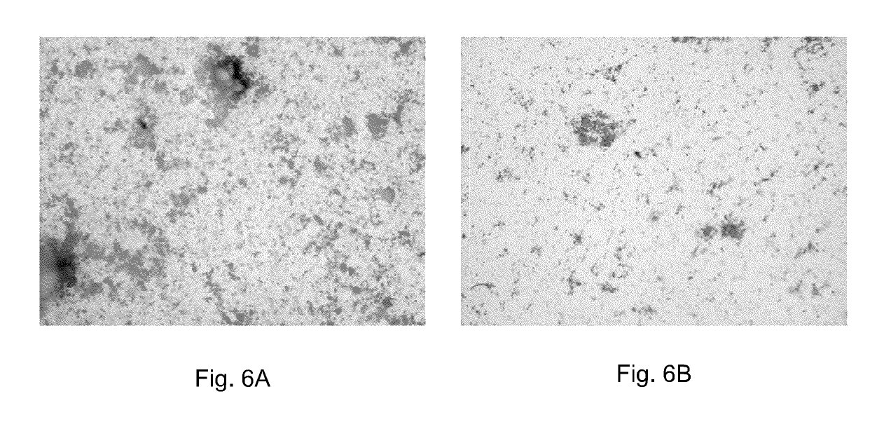

Examining Table 1, the glass transition temperature for the HEMA-MWCNTs appears to be clearly higher than each coating under all conditions, but was not found to be statistically different according to the statistical model used in this study. This can be attributed to the high amount of variability in the HEMA-CNT results. The difference between the observed glass transition temperatures can be attributed to non-instantaneous heat flow into the material. Carbon nanotubes are not geometrically straight (see FIGS. 6A and 6B), which may introduce varying amounts of added steric hindrance altering the glass transition temperature.

Further statistical analysis of the measured glass transition temperatures for the coatings indicated that glass transition temperature of the HEMA functionalized CNT/PU coating was not statistically different from the PU coating for the performed heat/cool/heat cycles. This result indicates that incorporating the HEMA-functionalized MWCNT had little to no effect on the glass transition of the coating.

### Example 5

### Optical Microscopy

The HEMA-functionalized CNT/PU films were further analyzed by optical microscopy. An optical microscope was attached to a Pacific Nanotechnology Atomic Force Microscope (AFM) (Santa Clara, Calif.) to observe the degree of dispersion at the microscopic level. Areas of interest were located with the integrated optical microscope and scanned by the AFM in contact mode with a resolution of 256 lines/image and a scan angle of zero. Two polyurethane coatings made with the HEMA-functionalized CNTs were examined, one with shear and one without.

Optical microscopy determined that the functionalized nanotubes were not completely de-agglomerated by the sonication process. The images show the functionalized nanotubes, within the as-fabricated coating grouped together in a colloidal fashion throughout the coating (FIG. 6A) indicating that complete dispersion was not achieved. A few agglomerates remained within these structures and can be seen without magnification, which can be attributed to the thickness of the film. There was no control over the thickness of the film as the coating was applied with a dropper and allowed to level by gravity. These structures were minimized when the thickness of the coating was controlled with the drawdown cube.

The optical clarity of the sheared coating, FIG. 6B, was visually better than the non-sheared coating due to the difference in thickness of the two coatings. There were also fewer agglomerates that were observable without magnification when compared to the non-sheared coating. This may be attributed to using an approximately 37 micron drawdown cube for application of the coating, as it is possible that agglomerates larger than about 37 microns were removed from the coating due to clearance problems.

### Example 6

### Atomic Force Microscopy

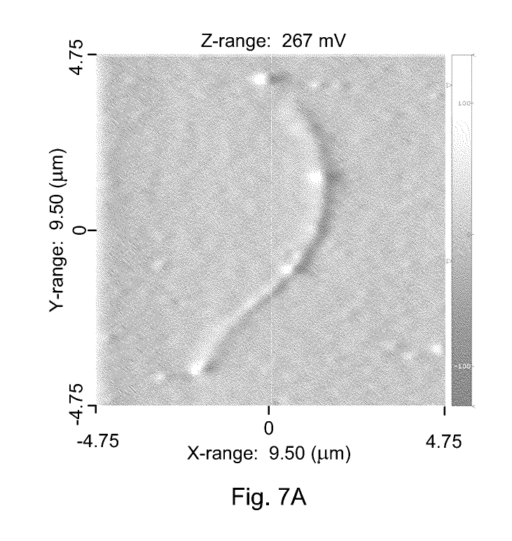

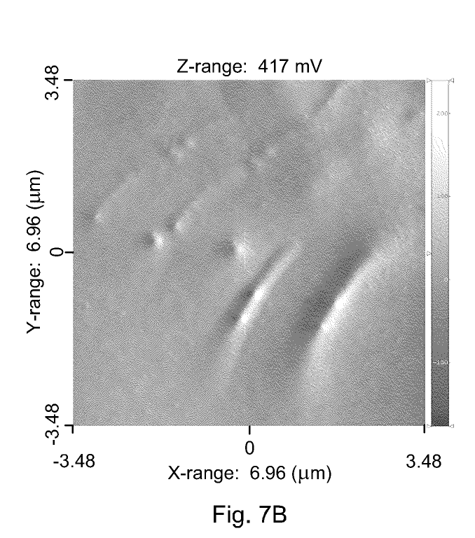

The sheared and non-sheared coatings, FIGS. 7A-B, respectively, were also examined by atomic force microscopy. The colloidal structures were located using the integrated optical microscope attached to the AFM, then scanned with a resolution of about 256 lines/image in contact mode with a scan angle of about 0°. The scans indicated that the MWCNTs were well dispersed within the colloidal structures, though agglomerates still present a problem. The colloidal structures found in the coatings can be larger than about 40 microns in diameter (determined by optical microscopy) though AFM scans do not show agglomerates larger than about 15 microns in diameter on the surface.

Two poly (HEMA)-functionalized CNT/polyurethane coatings were produced on glass slides with a single direction shear force (approximately 37 micron drawdown bar). Scans of the colloidal structures in the sheared coating indicate that some of the carbon nanotubes were successfully isolated within the coating (FIG. 7B). The substantially even spacing of the carbon nanotubes suggests the expected steric repulsion gained from polymer attachment suggesting the SIP was successful.

FIG. 7B further shows that the nanotubes are substantially aligned with the long axis normal to the shear direction with nearly equal spacing between the isolated tubes. This suggests nano-level dispersion within the colloidal structures. The one dimensional alignment of nanoparticles via shear has already been demonstrated with alumina and silica nanoparticles, (See Brickweg, Lucas., Floryancic, Bryce., Sapper, Erik., Fernando, Ray. J. Coat. Technol. Res. 2007, 4, 107) but few studies have investigated these effects using carbon nanotubes in a 2-component polyurethane coating as reported here.

In summary, systems and methods for isolation of carbon nanotubes are disclosed. The techniques involve combinations of mechanical separation via sonication combined with chemical functionalization using thermo-initiated or sono-initiated free radical polymerization and esterification.

Examples further illustrate the utility of this approach to isolate unbundled, multi-walled-carbon nanotubes via thermo-initiated or sono-initiated free radical polymerization of hydroxyethyl methacrylate with benzoyl peroxide. The functionalization was confirmed by attenuated total reflectance-Fourier transform infrared spectroscopy.

Other investigations have explored the use of these isolated CNTs in coating systems. For example, investigations using differential scanning calorimetry further determined that polyurethane coatings incorporating the HEMA-functionalized CNTs were statistically the same as polyurethane coatings with respect to their glass transition temperature, indicating that the introduction of HEMA-MWCNTs to the polyurethane has little effect on this property. The HEMA-functionalized MWCNTs formed large colloidal structures in both the non-sheared and sheared coatings as determined by optical microscopy, indicating that the formulation of the coating should be modified. The colloidal structures do not appear to be agglomerates, but localized regions of highly dispersed MWCNTs as determined by AFM.

The isolated tubes indicate that sonication can be used to successfully break apart most agglomerates, though some agglomerates remained in the coating that were approximately 15 microns in diameter. The viscous drag created by the applied shear force aligned the MWCNTs with the long axis normal to the shear direction indicating that shear alignment is possible in this system. This study determined a quick and easy method to functionalize MWCNTs for incorporation into a 2-component polyurethane coating and a simple method for producing ordered structures of the MWCNTs via shear forces was also observed.

### Example 7

### Continuous Fabrication of Functionalized CNTs

A mixture of CNTs and solvent were loaded into the container A, and a mixture of HEMA and solvent were loaded into the container B. Containers A and B were continuously flushed with nitrogen or another inert gas to expel oxygen. The CNTs in container A and the monomer HEMA in container B were continuously fed into a sonication tank. The mixture of CNTs, HEMA and solvent in the sonication tank was continuously sonicated.

The sonicated mixture was pumped from the sonication tank into a reaction vessel. The reaction vessel included a bath sonicator, a heating component to heat high enough to activate the catalyst, and metal tubing within the sonication chamber. The catalyst/initiator was introduced to the CNT and unsaturated compound mixture prior to entering the reaction vessel. The catalyst/initiator that can be introduced includes those described above.

The sonicated mixture was heated and sonicated continuously to produce a HEMA-CNT. The resulting functionalized CNTs were removed from the reaction vessel and washed several times for purification.

### Example 8

### Continuous Fabrication of Functionalized CNTs

A mixture of CNTs and solvent were loaded into the container A, and a mixture of HEMA and solvent were loaded into the container B. Containers A and B were continuously flushed with nitrogen or another inert gas to expel oxygen. The CNTs in container A and the monomer HEMA in container B were continuously fed into a sonication tank. The mixture of MWCNTs, HEMA and solvent in the sonication tank was pulse sonicated.

The sonicated mixture was pumped from the sonication tank into a reaction vessel. The reaction vessel included a bath sonicator, a heating component to heat high enough to activate the catalyst, and metal tubing within the sonication chamber. The catalyst/initiator was introduced to the CNT and unsaturated compound mixture prior to entering the reaction vessel. The catalyst/initiator that can be introduced includes those described above.

The sonicated mixture was heated and pulse sonicated to produce a HEMA-CNT. The resulting functionalized CNTs was extruded from the reaction vessel and washed several times for purification.

Although the foregoing description has shown, described, and pointed out the fundamental novel features of the present teachings, it will be understood that various omissions, substitutions, changes, and/or additions in the form of the detail of the apparatus as illustrated, as well as the uses thereof, can be made by those skilled in the art, without departing from the scope of the present teachings. The references referenced and listed herein are hereby incorporated by reference in their entirety.

We claim:

1. A method for continuous fabrication of functionalized carbon nanotubes by free radical polymerization, the method comprising:
selecting a plurality of carbon nanotubes;
combining the plurality of carbon nanotubes and an unsaturated compound having a functional group capable of chemically binding to a thermosetting matrix to provide a reaction mixture, wherein the plurality of carbon nanotubes and the unsaturated compound are continuously added into a reaction vessel; and
sonicating the reaction mixture to provide functionalized carbon nanotubes,
wherein the functionalized carbon nanotubes remain substantially separated.

2. The method of claim 1, wherein the carbon nanotubes are chemically modified using one of thermo-initiated or sono-initiated free radical polymerization and esterification.

3. The method of claim 1, wherein the unsaturated compound is selected from the group consisting of hydroxyethyl methacrylate (HEMA), cis-2-butene-1,4, diol, (meth)acrylic acid, maleamic acid, maleic anhydride and any combinations thereof.

4. The method of claim 1, wherein the sonication comprises continuous sonication.

5. The method of claim 1, wherein the sonication comprises pulse sonication.

6. The method of claim 1, wherein the functional group is selected from alcohol, acid, amide, anhydride, or any combinations thereof.

7. The method of claim 1, further comprising controlling the temperature of the reaction mixture during the sonicating.

8. A method for continuous forming functionalized carbon nanotubes, the method comprising:
selecting a plurality of carbon nanotubes;
combining the carbon nanotubes and one or more unsaturated compounds comprising a functional group to undergo a thermo-initiated or sono-initiated free radical surface polymerization reaction, wherein the carbon nanotubes and the unsaturated compound are continuously fed into a reaction vessel;
combining the carbon nanotube and the unsaturated compound with a catalyst selected from the group consisting of aromatic peroxide compounds to form a carbon nanotube mixture; and
subjecting the carbon nanotube mixture to sonication.

9. The method of claim 8, further comprising heating the carbon nanotube mixture.

10. The method of claim 8, further comprising acid purifying the carbon nanotubes.

11. The method of claim 8, wherein the carbon nanotubes comprise one of multi-walled carbon nanotubes (MWNTs), single-walled carbon nanotubes (SWNTs), double-walled carbon nanotubes (DWNTs) and few-walled carbon nanotubes (FWNTs).

12. The method of claim 8, wherein the concentration of the unsaturated compound in solution is in the range between about 25 to 100 vol. %.

13. The method of claim 7, wherein the concentration of the catalyst added to the carbon nanotube-HEMA mixture is in the range of between about 0.5 to 10 mg/ml of initiating species/ml solution.

14. The method of claim 8, wherein the catalyst comprises an aromatic radical producing species.

15. The method of claim 14, wherein the aromatic peroxide compound is benzoyl peroxide (BPO).

16. The method of claim 8, wherein the sonication is performed using ultrasonic frequencies ranging between about 10 to 100 kHz at about 600 W and an amplitude ranging from about 100 to 300 μm for between about one to sixty minutes.

17. The method of claim 8, further comprising heating the mixture at temperatures ranging between about ±20° C. of the activation temperature of the initiating species for about 10 to 60 min to facilitate functionalization of the carbon nanotubes with HEMA.

18. The method of claim 8, wherein the sonication comprises continuous sonication.

19. The method of claim 8, wherein the sonication comprises pulse sonication.

20. A method for continuous fabrication of carbon nanotubes, the method comprising:
selecting a plurality of carbon nanotubes;
acid purifying the carbon nanotubes;
combining the carbon nanotubes and one or more unsaturated compounds comprising a functional group to undergo a thermo-initiated or sono-initiated free radical surface polymerization reaction, wherein the one or more unsaturated compound is selected from the group consisting of hydroxyethyl methacrylate (HEMA), cis-2-butene-1,4-diol, and other compounds with nucleophilic or electrophilic functional groups, wherein the carbon nanotubes and the unsaturated compound are continuously fed into a reaction vessel;
combining the carbon nanotube and the unsaturated compound with a catalyst esterification capabilities to form a carbon nanotube mixture; and
sonicating the carbon nanotubes mixture to form functionalized carbon nanotubes,
wherein the functionalized carbon nanotubes remain separated and do not substantially re-agglomerate.

21. The method of claim 20, wherein the carbon nanotubes are selected from the group consisting of multi-walled carbon nanotubes (MWNTs), single-walled carbon nanotubes (SWNTs), double-walled carbon nanotubes (DWNTs) and few-walled carbon nanotubes (FWNTs).

22. The method of claim 20, wherein the concentration of the catalyst added to the carbon nanotube HEMA mixture is less than about 0.2 wt. %.

23. The method of claim 20, wherein the catalyst comprises one of HfCl₄-2THF and ZrCl₄-2THF.

24. The method of claim 20, where in sonication is performed using ultrasonic frequencies ranging between about 10 to 100 kHz at about 600 W and an amplitude ranging from about 100 to 300 μm for between about one to sixty minutes.

25. The method of claim 20, comprising further heating the mixture at temperatures ranging between about ±20° C. of the activation temperature of the initiating species for about 10 to 60 min to facilitate functionalization of the carbon nanotubes with HEMA.

26. The method of claim 20, wherein the sonication comprises continuous sonication.

27. The method of claim 20, wherein the sonication comprises pulse sonication.

28. A coating system comprising a polymer base and the functionalized nanotube made according to the method of claim 8.

29. The coating of claim 28, wherein the coating system is a polymer base selected from the group consisting of polyurethanes, epoxies, polyester resins, and any thermoplastics with similar polarity as the functionalizing species.

30. A coating system comprising a polymer base and the functionalized nanotube made according to the method of claim 20.

31. The coating of claim 30, wherein the coating system is a polymer base selected from the group consisting of polyurethanes, epoxies, polyester resins, and any thermoplastics with similar polarity as the functionalizing species.

32. A carbon nanotube functionalized by the method of claim 8.

33. A carbon nanotube functionalized by the method of claim 20.
